(19) United States
(12) Patent Application Publication
(10) Pub. No.: US 2024/0343577 A1
(43) Pub. Date: Oct. 17, 2024

(54) DUAL PRESSURE SYSTEM FOR PRODUCING NITRIC ACID AND METHOD OF OPERATING THEREOF

(71) Applicant: Yara International ASA, Oslo (NO)

(72) Inventors: Bent VIGELAND, Skien (NO); Halvor ØIEN, Porsgrunn (NO); Krzysztof BANASIAK, Trondheim (NO); Andre DE SMET, Terneuzen (NL); Peter FAUCONNIER, Grimbergen (BE)

(21) Appl. No.: 18/292,096

(22) PCT Filed: Aug. 25, 2022
(86) PCT No.: PCT/EP2022/073639

§ 371 Date: Jan. 25, 2024

(30) Foreign Application Priority Data
Aug. 25, 2021 (EP) 21193029.2
Jan. 11, 2022 (EP) 22150904.5
Mar. 3, 2022 (EP) 22160016.6

(51) Int. Cl. C01B 21/46; B01D 53/00; B01D 53/14; B01D 53/18; C01B 21/28; F28C 1/08

(52) U.S. Cl. CPC C01B 21/46; B01D 53/002; B01D 53/1456; B01D 53/1493; B01D 53/18; C01B 21/28; F28C 1/08; B01D 2252/103; B01D 2257/404; B01D 2258/02

(57) ABSTRACT

A production plant for producing nitric acid at reduced power, the system being derived from a state-of-the art dual pressure nitric acid plant wherein the system further includes a first feature for splitting a tail gas stream into a first tail gas stream in fluid communication with compressed air and with an oxygen-rich gas and a second tail gas stream, and/or a feature for splitting a tail gas stream into a third tail gas stream in fluid communication with compressed air and with an oxygen-rich gas and a fourth tail gas stream. The production plant allows for reduction of power by the air compressor. A method for operating the system, the use of the system for performing the method, and a method for revamping a state-of-the-art dual pressure nitric acid plant into the system.

### FIELD

The present disclosure relates to the field of nitric acid production in a dual pressure plant.

### BACKGROUND

Pure nitric acid is a clear, colorless liquid with a strong odor. Nitric acid is produced in large quantities principally by catalytic oxidation of ammonia (Ostwald process). Ammonia is converted to nitric acid in several stages. Ammonia is first oxidized in an ammonia burner on platinum gauzes (commonly called ammonia converter) or cobalt balls, producing nitric oxide (in this disclosure also called nitrogen monoxide (NO)) and water:

4NH₃(g)+5O₂(g)→4NO(g)+6H₂O(g) (1)

The reaction product from (1), nitric oxide, following cooling, is then oxidized to nitrogen dioxide (NO₂) and further to dinitrogen tetroxide N₂O₄(g) in an oxidation section:

2NO(g)+O₂(g)→2NO₂(g) (2)

2NO₂(g)→N₂O₄(g) (3)

Cooling of nitrogen oxide gases is accomplished first through the use of a waste heat recovery system recovering the heat from the conversion of ammonia into nitric oxide, then through the use of a cooler condenser in which condensed nitric acid is separated from nitric oxide, nitrogen dioxide and dinitrogen tetroxide and nitric acid gases, collectively called NOx gases, and finally by heating the tail gas released at the outlet of the absorption tower in which the NOₓ gases are absorbed.

By absorption in water, following compression through a NOₓ gas compressor, nitrogen dioxide and dinitrogen tetroxide are converted to nitric acid and nitric oxide:

3NO₂(g)+H₂O(l)→2HNO₃(aq)+NO(g) (4)

3N₂O₄(g)+2H₂O(l)→4HNO₃(aq)+2NO(g) (5)

Weak nitric acid which is up to 68% (azeotrope) is obtained. Through a rectification process the concentration of nitric acid can be increased up to 99% concentrated nitric acid. The total reaction is given by the following formula:

NH₃+2O₂→HNO₃+H₂O (6)

The main process units in a nitric acid production plant, include an ammonia converter (conversion of ammonia into nitric oxides using oxygen over a suitable catalyst), an oxidation section (conversion of nitric oxide into nitrogen dioxide and nitrogen tetroxide), an absorber unit (for the absorption of NOₓ gases into water) and a bleacher unit (removal of unreacted dissolved gases, containing in particular NOₓ and gases, from the aqueous nitric acid solution, which give it its typical brownish color).

The process for the production of nitric acid can be differentiated into a mono pressure (single-pressure) and dual pressure (split-pressure) process.

In a dual pressure process, the absorber unit operates at a higher working pressure than the ammonia converter. Modern dual pressure processes feature a low-pressure ammonia converter operating typically at 2 to 6 bara, and a high-pressure absorber unit operating at 9 to 16 bara.

A dual pressure process requires an air compressor to feed low-pressure air (which comprises about 21 vol % of oxygen) to the converter, and a NOₓ gas compressor to feed high-pressure NOₓ gases to the absorber unit. The working pressure of an air compressor is from 2 to 6 bara, inclusive, and the working pressure of a NOₓ gas compressor is from 9 to 16 bara, inclusive.

The drive power for the air compressor typically originates from a tail gas turbine and a steam turbine or a power source such as an electric motor. Accordingly, the compressor train of a dual pressure nitric acid production plant typically comprises an air compressor, a NOₓ gas compressor, a tail gas turbine, and a steam turbine or a power source such as an electric motor.

More in detail, referring to FIG. 1, a dual pressure plant and process according to the prior art works as follows. Gaseous ammonia 32, optionally pre-heated in a pre-heater unit (not shown) is mixed with compressed air 34 pressurised to a low pressure using an air compressor 36, in a mixing apparatus 35, and the resulting ammonia/oxygen-enriched air mixture 14 is fed to an ammonia converter 37, operating at a low pressure, where ammonia is oxidized over a suitable catalyst, thus obtaining a LP NOₓ gas/steam mixture 15, comprising water and nitric oxide (NO). The heat of the mixture coming out of the ammonia converter is recovered, after which the NOₓ gas/stream mixture is subsequently cooled down in a gas cooler/condenser 38 to temperature where the water condenses, and an aqueous diluted nitric acid mixture 17 is separated from a gaseous NOₓ stream 22. The gaseous NOₓ stream 22 is sent to a NOₓ gas compressor 40 wherein its pressure is elevated from a low pressure to a high pressure, being about equal to the operating pressure of an absorber unit 41. The aqueous diluted nitric acid mixture 17 is sent to the absorber unit 41, commonly called absorption tower. The pressurised NOₓ gas stream 24 is further oxidized to further convert the NO to NO₂ and N₂O₄, cooled in an additional gas cooler/condenser 39 and then directed to the absorption tower 41. Inside the absorption tower 41, the pressurised NOₓ gas stream 24 reacts with water to produce the tail gas 5 and a stream of raw nitric acid 27 also containing residual NOₓ gas, which is fed to a bleacher 62. The residual NOₓ gas in the raw nitric acid stream 27 is then stripped out with a gaseous medium 72 such as an oxygen-containing gas or air, inside the bleacher unit 62 operating at low-pressure; the bleacher unit is generally operated at about the same pressure as the ammonia converter. The drive power for both the air compressor 36 and the NOₓ gas compressor 40 originates from a tail gas expander 7 and a steam turbine 51 or a power source such as an electric motor (not shown). The heat generated in the ammonia converter 37 is used for heating the tail gas 5 in the tail gas heat exchanger 43 comprising the heat exchangers 66 and 67, the tail gas heater being therefore optionally present. The tail gas 5 exchanges heat with the NOₓ gas/steam mixture 15 in the heat exchange system 43 and is expanded in the tail gas expander 7.

The air used for the oxidation of ammonia is commonly denoted as primary air; the air used as stripping medium in the bleacher unit is commonly denoted as secondary air.

According to the prior art, the revamping of the nitric acid production plants to increase its capacity is commonly based on increasing the amount of primary air to the reactor, which leads to a proportional increase of the amount of nitric acid produced.

The increase of the amount of primary air in the reactor entails the installation of a new air compressor or the revamping of the existing one. The increase of the primary air also causes a higher amount of gas to be processed subsequently into the NOₓ gas compressor. This entails the further revamping of the NOₓ gas compressor or the installation of a new one, and the modification or replacement of the tail gas and/or the steam-turbines and/or the electrical motor. Otherwise, the NOx gas compressor would easily achieve its process limit, thus becoming the bottleneck of the plant.

However, the revamping has significant drawbacks. First of all, it entails elevated costs for the modification or replacement of the existing equipment, i.e. the air compressor, the NOₓ gas compressor and the corresponding turbines and electrical motor. In addition, the revamping of the equipment is also technically demanding leading to long plant downtime.

Another problem related to nitric acid production plants is the high amount of energy required in order to operate the air compressor. Consequently, a high amount of energy is required to achieve the targeted nitric acid production throughput.

A goal of the present invention, therefore, is to provide a system and a method for operating the system which allows for the reduction or even suppression of power required to operate the air compressor in a dual nitric acid plant.

In CN110540178A (China Chengda Engineering Co Ltd, 2019), a process for producing nitric acid is disclosed. Nitric acid is produced by a medium pressure method, which is characterized in that it comprises the following steps: the ammonia oxidation and absorption pressure is 0.5-0.6 MPa; enabling the tail gas leaving the absorption tower to pass through a carbon molecular sieve Temperature Swing Adsorption (TSA) treatment device to reduce the content of nitrogen oxides in the tail gas to be less than 100 mg/Nm³; the process air of the air compressor is used as the regeneration desorption gas of the carbon molecular sieve temperature swing adsorption treatment device, and the regeneration desorption gas containing the nitrogen oxide can be returned to the ammonia oxidation reactor for reuse; adding a layer of N₂O decomposition catalyst in the oxidation reactor to reduce the content of N₂O to 50-100 PPM through reaction; the nitric acid bleaching tower is arranged at the bottom of the absorption tower, and the two towers are integrated, so that the process flow is shortened, and the equipment investment is reduced. With regard to the amount of air being compressed by the air compressor, however, the same amount of air is to be compressed as would be in the absence of the TSA unit: in the presence of the TSA unit, the amount of air being compressed is initially split between the TSA unit and the ammonia oxidation reactor directly and, in the end, with the amount of compressed air leaving the TSA unit being directed also to the ammonia oxidation reactor, the total amount of air compressed by the air compressor ends up in the ammonia oxidation reactor.

In WO2018/162150A1 (Casale S A, 13 Sep. 2018) a solution is proposed to overcome the revamping drawbacks. WO2018162150A1 discloses a dual pressure plant for the production of nitric acid comprising a reactor providing a gaseous effluent containing nitrogen oxides, an absorber unit in which nitrogen oxides react with water providing raw nitric acid and, the absorber unit operating at a pressure greater than the pressure of the reactor, a compressor elevating the pressure of the reactor effluent to the absorber unit pressure, the plant also comprising a first HP bleacher unit and a second LP bleacher unit, the first HP bleacher unit stripping with air the NOₓ gas from the output stream of the absorber unit, thus providing a partially stripped nitric acid stream and a nitrogen oxides-loaded air stream, the former being fed to the second LP-bleacher unit and the latter being recycled to the oxidation section, upstream of the NOₓ gas compressor.

A further air compressor is also provided, which supplies the first HP bleacher unit with air. Hence, energy is required in order to operate a first HP bleacher unit at a high-pressure and then recycle NOₓ gases to the delivery side of the NOₓ gas compressor.

Therefore, there remains a need for a process and a corresponding plant setup for minimizing or even suppressing the amount of energy required in order to operate the NOₓ gas compressor and, in particular, also the air compressor, in order to avoid bottle-necks in the nitric acid production throughput associated with those compressors.

### SUMMARY

In one aspect of the disclosure, a production plant for producing nitric acid at reduced power consumption and reduced emissions, comprising:
an air compressor providing compressed air;
a supply for a first oxygen-rich gas, such as a high-pressure water electrolyzer, in fluid communication with compressed air, the mixing of the first oxygen-rich gas and of compressed air providing part of a first oxygen-containing gas;
a mixing apparatus, for mixing the first oxygen-containing gas with an ammonia gas stream, to produce an ammonia/oxygen-containing gas mixture;
an ammonia converter operable at a pressure equal to or higher than P1 and lower than P2, for oxidising ammonia in the ammonia/oxygen-containing gas mixture, to produce a NOx gas/steam mixture comprising water and nitric oxide;
a means for regulating the concentration of ammonia and/or of oxygen in the ammonia converter, particularly a means for controlling the flow of the first oxygen-rich gas in the oxygen-containing gas and/or a means for controlling the flow of the ammonia gas stream, for maintaining the oxygen to ammonia molar ratio inside the ammonia converter at a ratio of at least 1.2, in particular between 1.2 and 9;
a first gas cooler/condenser downstream the ammonia converter, to produce an aqueous diluted nitric acid mixture and a gaseous NOₓ stream;
a NOx gas compressor for compressing the gaseous NOx stream, to produce a compressed NOₓ gas stream at a pressure P2;
an absorption tower for absorbing the NOₓ gases from the compressed NOₓ gas stream in water, to produce a stream of raw nitric acid-containing residual NOₓ gas and a tail gas comprising NOₓ gases, comprising an absorption tower tail gas outlet for evacuating the tail gas;
a heat exchange system located upstream the gas cooler/condenser for heating a tail gas stream with the heat from the NOₓ gas/steam mixture coming from the ammonia converter;
a second gas cooler/condenser for separating and condensing steam from the compressed NOₓ gas stream before the stream is provided to the absorption tower;
a second oxygen-containing gas, having either:
   a) a pressure equal to or higher than P1 and up to P2, for supplying oxygen downstream the ammonia converter and upstream the NOₓ gas compressor; or
   b) a pressure higher than P2, for supplying oxygen to the compressed NOₓ gas stream;
a means for controlling the flow of the second oxygen-containing gas such that a tail gas stream contains at least 0.5% by volume oxygen; and
a first pressure release means located downstream the heat exchange system, for expanding a tail gas stream, to produce a first expanded tail gas at a pressure equal to or higher than P1 and lower than P2, wherein the first pressure release means can at least partly power the NOₓ gas compressor and/or the air compressor.
   The production plant is characterized in that the production plant further comprises:
a first and/or a second means for splitting a gas stream, wherein
(i) the first means for splitting is a means for splitting a tail gas stream into a first tail gas stream and a second tail gas stream, wherein the first tail gas stream has a pressure equal to or higher than P1 and up to P2 and is in fluid communication with the first oxygen-rich gas and compressed air, and wherein the mixing of compressed air, the first oxygen-rich gas and the first tail gas stream provides the first oxygen-containing gas, and
(ii) the second means for splitting is a means for splitting a tail gas stream into a third tail gas stream and a fourth tail gas stream, wherein the third tail gas stream has a pressure equal to or higher than P1 and up to P2 and is in fluid communication with compressed air and the first oxygen-rich gas, and wherein the mixing of the third tail gas, compressed air and the first oxygen-rich gas provides the second oxygen-containing gas, and wherein the second oxygen-containing gas is supplied downstream the ammonia converter and upstream the NOₓ gas compressor;
   or
   the second means for splitting is a means for splitting a tail gas stream into a third tail gas stream and a fourth gas stream, and wherein the third tail gas stream is in fluid communication with compressed air and the first oxygen-rich gas, and wherein the mixing of the third tail gas, compressed air and the first oxygen-rich gas and the pressurization of the mixed third tail gas, compressed air and the first oxygen-rich gas in a means for pressurizing provide the second oxygen-containing gas at a pressure higher than P2, and wherein the second oxygen-containing gas is supplied downstream the NOₓ gas compressor and upstream the absorption tower.

In one embodiment according to the production plant of the disclosure, the production plant further comprises a means for controlling the flow of the first and/or third tail gas stream.

The inventors have found that, instead of supplying primary and secondary air solely as compressed air provided by an air compressor, it is possible to recirculate the first tail gas stream and/or the third tail gas stream, provided by the first means for splitting and the second means for splitting, respectively. The oxygen-rich gas and the second oxygen-containing gas provide oxygen to the ammonia converter and to the absorption tower, respectively, such that, even at reduced amounts of compressed air provided by the air compressor, the concentration of oxygen in the ammonia converter and in the absorption tower is at least equal to that in a state-of-the-art dual pressure nitric acid plant.

Therefore, tail gas, particularly with controlled oxygen content, can be recirculated both as primary and secondary air. Consequently, less compressed air is to be supplied such that less air has to be compressed and the power demand on the air compressor is reduced. At the same time, the size of the air compressor and that of a conventional gas expander, in which the tail gas is expanded in a state-of-the-art mono pressure nitric acid plant, are reduced, such that the footprint of the plant is reduced. Furthermore, the NOₓ emissions leaving the production plant are also reduced. Consequently, the size of the treatment unit for treating those NOₓ emissions is reduced with respect to the size in the corresponding state-of-the art mono pressure nitric acid plant. Also, the separate supply of the pressurized oxygen or oxygen-rich gas ensures an optimal conversion of ammonia to nitric oxide.

In one embodiment according to the production plant of the disclosure, the production plant further comprises the production plant further comprises one or more of:
a steam turbine, wherein the steam turbine can at least partly power the NOₓ gas compressor and/or the air compressor;
a heat exchanger, for exchanging heat between the first expanded tail gas and a tail gas stream, particularly a colder tail gas stream, wherein the first expanded tail gas exits the heat exchanger at a temperature below 300° C., wherein:
   the first expanded tail gas having exchanged heat with the tail gas is further supplied to the first means for splitting, particularly the first expanded tail gas downstream the heat exchanger is in direct fluid communication with the first means for splitting; and/or
   the tail gas at the outlet of the absorption tower is split into a third tail gas stream and a fourth tail gas stream, particularly the tail gas stream colder than the first expanded tail gas is split into a third tail gas stream and a fourth tail gas stream;
a De-NOₓ treatment unit; and
a second pressure release means for expanding the second tail gas stream to atmospheric pressure, to produce a second expanded tail gas.

In one embodiment according to the production plant of the disclosure, the production plant further comprises a bleacher for bleaching the stream of raw nitric acid-containing residual NOₓ gas, to provide a stream of bleached nitric acid, having an inlet in fluid communication with a high-pressure water electrolyzer supplying an oxygen-rich bleaching gas, and an outlet for off-gases in fluid communication with any gas stream downstream the ammonia converter and upstream the NOₓ gas compressor if the bleacher operates at a pressure equal to or higher than P1 and up to equal to P2, or in fluid communication with any stream downstream the NOₓ gas compressor and upstream the absorption tower and upstream the absorption tower if the bleacher operates at a pressure higher than P2, such that the supply for the second oxygen-containing gas comes at least partly from the off-gases.

In one embodiment according to the production plant of the disclosure, the production plant further comprises a stream of a second oxygen-rich gas in direct fluid communication with any tail gas stream, particularly a stream of a pressurized oxygen-rich gas in direct fluid communication with any tail gas stream upstream the first pressure release means.

In one embodiment according to the production plant of the disclosure, the production plant further comprises the first oxygen-rich gas, the second oxygen-rich gas, the second oxygen-containing gas, the oxygen-rich bleaching gas and the off-gases are all at least partly provided by a high-pressure water electrolyzer.

In one aspect of the disclosure, a method for producing nitric acid at reduced power consumption and reduced emissions, in a production plant according to the production plant of the disclosure, is disclosed. The method comprises the steps of:
a) compressing air in the air compressor, thereby providing compressed air;
b) supplying compressed air obtained in step a) to the mixing apparatus;
c) supplying the ammonia gas stream to the mixing apparatus, thereby producing the ammonia/oxygen-containing gas mixture;
d) oxidising ammonia in the ammonia/oxygen-containing gas mixture in the ammonia converter at a pressure equal to or higher than P1 and lower than P2, thereby producing the gaseous NOₓ gas/steam mixture comprising water and nitric oxide;
e) cooling the NOₓ gas in the gaseous NOₓ gas/steam mixture in the heat exchange system and in the gas/cooler condenser, thereby producing an aqueous diluted nitric acid mixture and the gaseous NOₓ stream;
f) compressing the gaseous NOₓ stream in the NOₓ gas compressor, thereby providing the pressurised NOₓ compressed gas stream having a pressure P2;
g) absorbing the pressurised gaseous NOₓ stream in the absorption tower, thereby providing the stream of raw nitric acid-containing residual NOₓ gas and the tail gas comprising NOₓ gases;
h) heating the tail gas in the heat exchange system, with the heat from the NOₓ gas/steam mixture coming from the ammonia converter, particularly to a temperature ranging from 150 to 650° C.;
i) cooling the compressed NOₓ gas stream in the additional gas cooler/condenser, in particular thereby providing the compressed NOₓ gas stream having a temperature ranging from 20 to 60° C.; and
j) expanding at least part of the tail gas obtained in step h) in the first pressure release means, thereby providing the first expanded tail gas.
   The method is characterized in that it further comprises the steps of:
k) splitting a tail gas stream, particularly a stream of tail gas downstream the absorption tower, with the first means for splitting into the first tail gas stream and the second tail gas stream, and/or with the second means for splitting into the third tail gas stream and the fourth tail gas stream;
l) mixing the first tail gas stream with the first oxygen-rich gas and compressed air, thereby providing the first oxygen-containing gas, and/or mixing the third tail gas stream with compressed air and the first oxygen-rich gas, thereby providing the second oxygen-containing gas;
m) adjusting the flow of the first oxygen-rich gas being mixed in step l) or the flow of the ammonia gas stream, such as to maintain the oxygen to ammonia molar ratio inside the ammonia converter to a ratio of at least 1.2, in particular between 1.2 and 9;
n) supplying the first oxygen-containing gas to the mixing unit;
o) adjusting the flow of the second oxygen-containing gas such that a tail gas stream, particularly a tail gas stream downstream the absorption tower, contains at least 0.5% by volume oxygen; and
p) supplying the second oxygen-containing gas at a pressure equal to or higher than P1 and up to P2 downstream the ammonia converter and upstream the NOₓ gas compressor, or at a pressure higher than P2 downstream the NOₓ gas compressor and upstream the absorption tower.

In one embodiment according to the method of the disclosure, the method further comprises the step of:
q) adjusting the flow of the first and/or the third tail gas stream.

In one embodiment according to the method of the disclosure, the first tail gas stream is mixed in step l), and wherein the first expanded tail gas is split in step k), and wherein the method further comprises the steps of:
r) before step h), heating up, in the heat exchanger, the tail gas obtained in step g) with the first expanded tail gas obtained in step j), in particular, heating up, in the heat exchanger, the tail gas stream colder than the first expanded tail gas with the first expanded tail gas obtained in step j), thereby bringing the tail gas to be mixed in step l) to a temperature below 300° C.;
s) treating the tail gas obtained in the De-NOₓ treatment unit before step h) and after step r), particularly treating the tail gas stream heated from step r) in the de-NOx unit;
t) expanding the second tail gas stream in the second pressure release means, thereby providing the second expanded tail gas; and
u) recovering at least part of the heat energy generated in the ammonia converter in the steam turbine.

In one embodiment according to the method of the disclosure, the third tail gas stream is mixed in step l), and wherein the tail gas obtained in step g) is split in step k) into a third tail gas stream and a fourth tail gas stream.

In one embodiment according to the method of the disclosure, the method further comprises the step of:
v) bleaching the stream of raw nitric acid-containing residual NOₓ gas obtained in step g) in the bleacher, thereby producing the stream of bleached nitric acid.

In one embodiment according to the method of the disclosure, the method further comprises the step of:
w) supplying the stream of the second oxygen-rich gas, particularly as a stream of a pressurized oxygen-rich gas, to a tail gas stream, particularly upstream the first pressure release means.

In one embodiment according to the method of the disclosure, the method further comprises the step of:
x) operating the high-pressure water electrolyzer, thereby producing pressurized oxygen-gas; and
y) providing, from the oxygen produced by the water electrolyzer in step x), at least part of the first oxygen-rich gas, the second oxygen-containing gas, the second oxygen-rich gas, the oxygen-rich bleaching gas and the oxygen-rich off-gases.

In one aspect of the disclosure, the use of the production plant of the disclosure for performing the method of the disclosure, is disclosed.

In one aspect of the disclosure, method for revamping an existing production plant for producing nitric acid, wherein the existing production plant comprises:
an air compressor for providing a compressed air stream;
a mixing apparatus, for mixing compressed air stream with an ammonia gas stream, to produce an ammonia/oxygen-containing gas mixture;
an ammonia converter operable at a pressure equal to or higher than P1 and lower than P2, for oxidising ammonia in the ammonia/oxygen-containing gas mixture, to produce a NOₓ gas/steam mixture comprising water and nitric oxide;
a first gas cooler/condenser, downstream the ammonia converter, to produce an aqueous diluted nitric acid mixture and a gaseous NOₓ stream;
a NOx gas compressor for compressing the gaseous NOx stream, to produce a compressed NOx gas stream at a pressure P2;
an absorption tower for absorbing the NOₓ gases from the compressed NOₓ gas stream in water, to produce a stream of raw nitric acid-containing residual NOₓ gas and a tail gas comprising NOₓ gases, comprising an absorption tower tail gas outlet for evacuating the tail gas;
a heat exchange system for heating a tail gas stream with the heat from the NOₓ gas/steam mixture coming from the ammonia converter;
a second gas cooler/condenser for separating and condensing steam from the compressed NOₓ gas stream before it is absorbed in the absorption tower; and
first pressure release means for expanding a tail gas stream, to produce a first expanded tail gas at a pressure equal to or higher than P1 and lower than P2, wherein the first pressure release means can at least partly power the NOₓ gas compressor;
   into a production plant according to the production plant of the disclosure, is disclosed. The revamping method comprises the steps of:
introducing a supply for a first oxygen-rich gas, such as a high-pressure water electrolyzer, in fluid communication with compressed air;
introducing a means for regulating the concentration of ammonia and/or of oxygen in the ammonia converter, particularly a means for controlling the flow of the first oxygen-rich gas in the oxygen-containing gas and/or a means for controlling the flow of the ammonia gas stream, for maintaining the oxygen to ammonia molar ratio inside the ammonia converter at a ratio of at least 1.2, in particular between 1.2 and 9;
introducing a supply for a second oxygen-containing gas, having either:
   (a) a pressure equal to or higher than P1 and up to P2, for supplying oxygen upstream the NOₓ gas compressor; or
   (b) a pressure higher than P2, for supplying oxygen to the compressed NOₓ gas stream,

such that a tail gas stream contains at least 0.5% by volume oxygen;
introducing a first means for splitting and/or a second means for splitting a stream of tail gas downstream the absorption tower, wherein
   (i) the first means for splitting is a means for splitting a tail gas stream into a first tail gas stream and a second tail gas stream, and wherein the first tail gas stream has a pressure equal to or higher than P1 and up to P2 and is in fluid communication with the first oxygen-rich gas and compressed air, and wherein the mixing of compressed air, the first oxygen-rich gas and the first tail gas stream provides the first oxygen-containing gas, and
   (ii) the second means for splitting is a means for splitting a tail gas stream into a third tail gas stream and a fourth tail gas stream, wherein the third tail gas stream has a pressure equal to or higher than P1 and up to P2 and is in fluid communication with compressed air and the first oxygen-rich gas, and wherein the mixing of the third tail gas, compressed air and the first oxygen-rich gas provides the second oxygen-containing gas, and wherein the second oxygen-containing gas is supplied downstream the ammonia converter and upstream the NOₓ gas compressor;
      or
      the second means for splitting is a means for splitting a tail gas stream into a third tail gas stream and a fourth gas stream, and wherein the third tail gas stream is in fluid communication with compressed air and the first oxygen-rich gas, and wherein the mixing of the third tail gas, compressed air and the first oxygen-rich gas and the pressurization of the mixed third tail gas, compressed air and the first oxygen-rich gas in a means for pressurizing provide the second oxygen-containing gas at a pressure higher than P2, and wherein the second oxygen-containing gas is supplied downstream the NOₓ gas compressor and upstream the absorption tower.

### BRIEF DESCRIPTION OF THE FIGURES

FIG. 1: Nitric acid plant according to the prior art comprising an ammonia converter (37) operating at a pressure equal to or higher than P1 and lower than the operating pressure (P2) of the absorption tower (41)

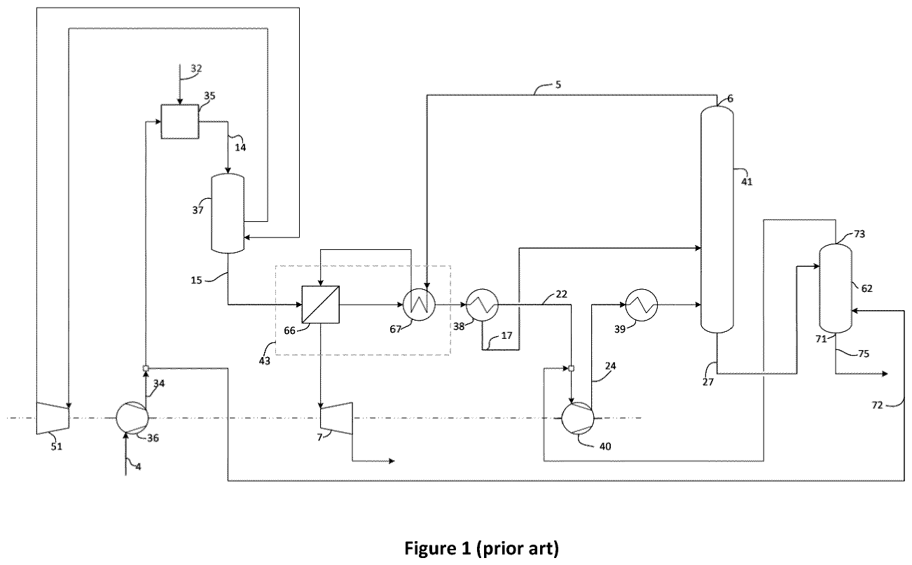

FIG. 2A: Nitric acid plant according to the disclosure comprising an oxygen-containing gas (67) at a pressure equal to or higher than the operating pressure than the ammonia converter (37) and lower than the operating temperature of the absorption tower (41)

FIG. 2B: Nitric acid plant according to the disclosure comprising an oxygen-containing gas (67) at a pressure higher than the operating temperature of the absorption tower (41)

FIG. 3A: Nitric acid plant according to the disclosure comprising a bleacher (62) operating at a pressure equal to or higher than the operating pressure than the ammonia converter (37) and lower than the operating temperature of the absorption tower (41)

FIG. 3b: Nitric acid plant according to the disclosure comprising a bleacher (62) operating at a pressure equal to higher than the operating temperature of the absorption tower (41)

Table of numerals

| | |
|---|---|
| 4 | air |
| 5 | tail gas |
| 6 | outlet of nitric acid absorption tower |
| 7 | First pressure release means |
| 10 | first tail gas stream |
| 14 | ammonia/oxygen-containing gas mixture |
| 15 | NOₓ gas/steam mixture |
| 17 | aqueous diluted nitric acid mixture |
| 18, 22 | gaseous NOₓ stream |
| 24 | compressed NOₓ gas having a pressure P2 |
| 27 | stream of raw nitric acid-containing residual NOₓ gas |
| 32 | ammonia |
| 34 | compressed air |
| 35 | mixing apparatus |
| 36 | air compressor |
| 37 | ammonia converter operable at a pressure equal to or |
| | higher than P1 and lower than P2 |
| 38 | gas cooler/condenser |
| 39 | additional gas cooler/condenser |
| 40 | NOₓ gas compressor |
| 41 | absorption tower |
| 43 | heat exchange system |
| 50 | first oxygen-rich gas |
| 51 | steam turbine |
| 55 | first means for splitting a tail gas stream |
| 56 | first oxygen-containing gas |
| 60 | second pressure release means |
| 62 | bleacher |
| 63 | high-pressure water electrolyzer |
| 64 | expanded tail gas |
| 66 | first heat exchanger of the heat exchange system 43 |
| 67 | second heat exchanger of the heat exchange system 43 |
| 68 | second oxygen-containing gas having a pressure equal to |
| | or higher than P1 and up to P2, or a pressure higher than P2 |
| 69 | second expanded tail gas |
| 70 | De-NOₓ treatment unit |
| 71 | outlet for bleached nitric acid |
| 72 | oxygen-rich bleaching gas |
| 73 | outlet of the bleacher |
| 74 | stream of a second oxygen-rich gas |
| 75 | bleached nitric acid |
| 77 | off gases from the outlet 73 of the bleacher 62 |
| 78 | means for pressurizing |
| 79 | heat exchanger |
| 80 | second tail gas stream |
| 81 | inlet of the bleacher 62 for the oxygen-rich bleaching gas 72 |
| 82 | second means for splitting a tail gas stream |
| 83 | third tail gas stream having a pressure equal to or higher |
| | than P1 and lower than P2 |
| 84 | third tail gas stream having a pressure higher than P2 |
| 85 | fourth tail gas stream |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “ranging from . . . to . . . ” or “range from . . . to . . . ” or “up to” as used when referring to a range fora measurable value, such as a parameter, an amount, a time period, and the like, is intended to include the limits associated to the range that is disclosed.

Where the term “about” when applied to a particular value or to a range, the value or range is interpreted as being as accurate as the method used to measure it.

The present disclosure generally relates to a system and method for the production of nitric acid, particularly in a dual pressure production plant, with important gains compared to conventional systems and methods, wherein the conventional primary air and/or secondary air consisting of pressurized air is partially replaced by the combination of (i) oxygen gas or an oxygen-rich gas, in particular a pressurized oxygen gas or oxygen-rich gas, such as produced by a high-pressure water electrolyzer as further discussed herein; and (ii) a recirculated tail gas stream. Stated differently, in the system and methods for the production of nitric acid according to the present disclosure:
(i) oxygen gas or an oxygen-rich gas, in particular a pressurized oxygen gas or oxygen-rich gas, such as produced by a high-pressure water electrolyzer, is used mixed with the compressed air and, in particular, with part of the tail gas stream, to provide a first oxygen-containing gas stream, which is mixed with an ammonia gas stream and subsequently provided to the ammonia converter, and (b) is used to provide a second oxygen-containing gas stream downstream of the ammonia convertor, such as a second oxygen-containing gas stream which is mixed with a NOx containing gas stream downstream of the ammonia convertor, such as in an oxidation section and/or upstream of the absorber, and/or which is used as a stripping gas in a bleacher, wherein, in particular, the oxygen containing bleacher off-gases are subsequently mixed with a NOx containing gas stream downstream of the ammonia convertor and upstream of the absorber; and
(ii) the tail gas exiting the absorber is split in a first tail gas stream and a second tail gas stream and/or a third and a fourth tail gas stream, wherein the first tail gas stream is mixed with the oxygen gas or the oxygen-rich gas, in particular the pressurized oxygen gas or oxygen-rich gas, such as produced by a high-pressure water electrolyzer, and with the pressurized air, to provide the first oxygen-containing gas stream; and/or wherein part of the tail gas exiting the absorber, in particular the third tail gas stream, may also be mixed with the oxygen gas or oxygen-rich gas, in particular the pressurized oxygen gas or oxygen-rich gas, such as produced by a high-pressure water electrolyzer, to provide the second oxygen-containing gas stream.

### Dual Pressure Production Plant for Producing Nitric Acid

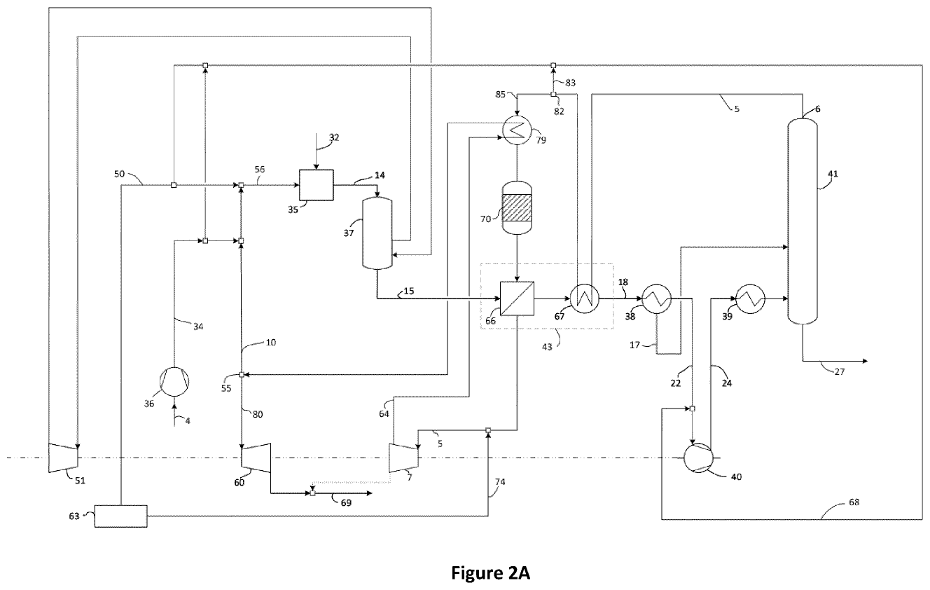

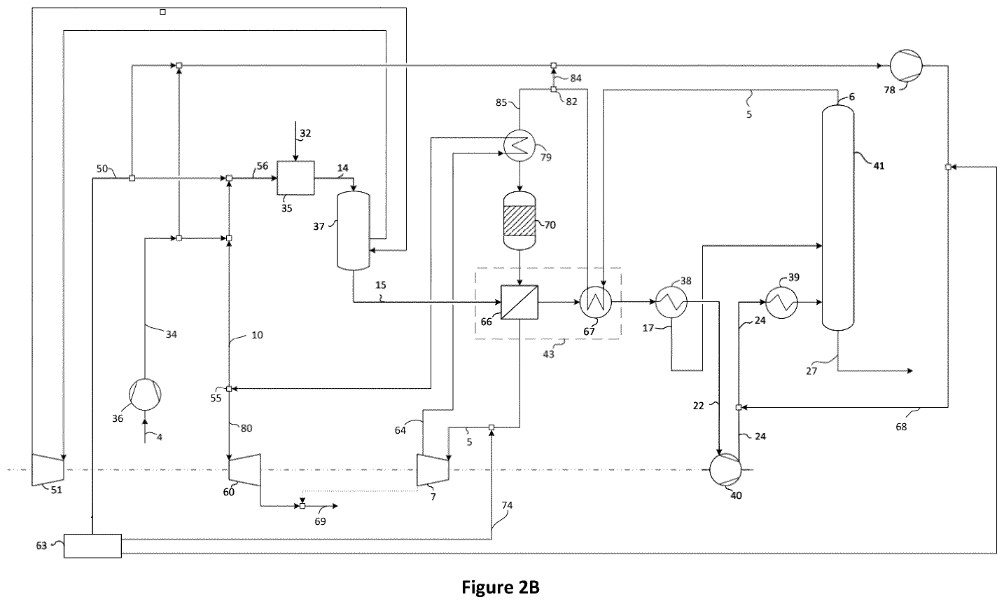

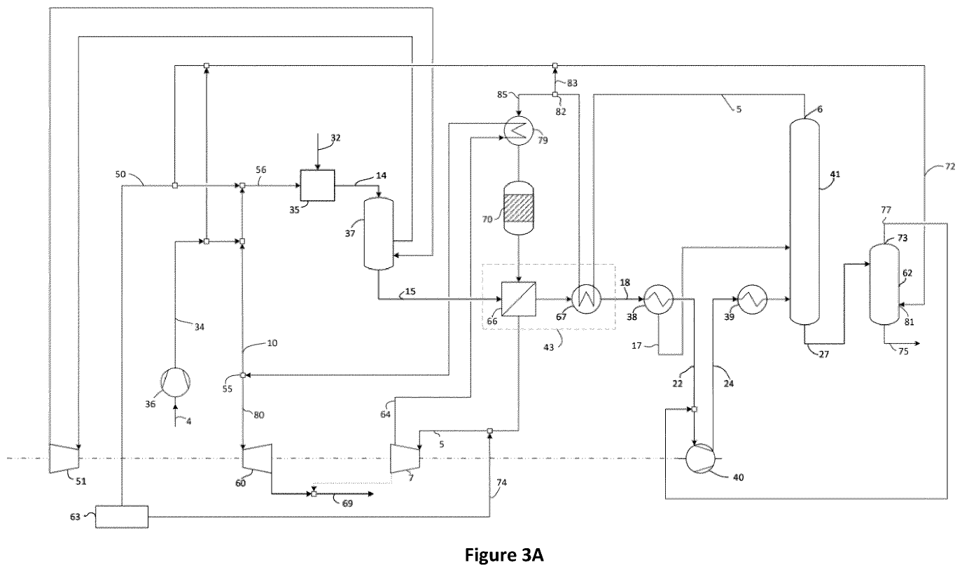

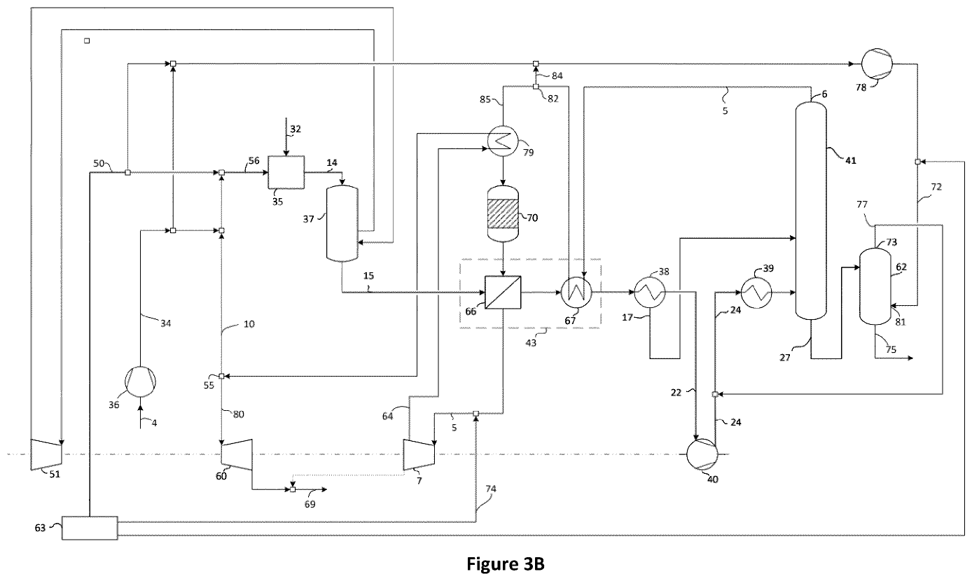

Reference is made to FIGS. 2A, 2B, 3A and 3B.

In one aspect of the disclosure, a production plant for producing nitric acid at reduced power consumption and reduced emissions, comprising an air compressor 36 providing compressed air 34; a supply for a first oxygen-rich gas 50 in fluid communication with compressed air 34, the mixing of the first oxygen-rich gas 50 and of compressed air 34 providing part of a first oxygen-containing gas 56; a mixing apparatus 35, for mixing the first oxygen-containing gas 56 with an ammonia gas stream 32, to produce an ammonia/oxygen-containing gas mixture 14; an ammonia converter 37 operable at a pressure equal to or higher than P1 and lower than P2, for oxidising ammonia in the ammonia/oxygen-containing gas mixture 14, to produce a NOₓ gas/steam mixture 15 comprising water and nitric oxide; a means for regulating (not shown) the concentration of ammonia and/or of oxygen in the ammonia converter 37, particularly a means for controlling the flow of the first oxygen-rich gas 50 in the oxygen-containing gas 56 and/or a means for controlling the flow of the ammonia gas stream 32, for maintaining the oxygen to ammonia molar ratio inside the ammonia converter 37 at a ratio of at least 1.2, in particular between 1.2 and 9; a first gas cooler/condenser 38 downstream the ammonia converter 37, to produce an aqueous diluted nitric acid mixture 17 and a gaseous NOₓ stream 22; a NOₓ gas compressor 40 for compressing the gaseous NOₓ stream 22, to produce a compressed NOₓ gas stream 24 at a pressure P2; an absorption tower 41 for absorbing the NOₓ gases from the compressed NOₓ gas stream 24 in water, to produce a stream of raw nitric acid-containing residual NOₓ gas 27 and a tail gas 5 comprising NOₓ gases, comprising an absorption tower tail gas outlet 6 for evacuating the tail gas 5; a heat exchange system 43 located upstream the gas cooler/condenser 38 for heating a tail gas stream with the heat from the NOₓ gas/steam mixture 15 coming from the ammonia converter 37; a second gas cooler/condenser 39 for separating and condensing steam from the compressed NOₓ gas stream 24 before the stream is provided to the absorption tower 41; a second oxygen-containing gas 68, 72,77, having either a) a pressure equal to or higher than P1 and up to P2, for supplying oxygen downstream the ammonia converter 37 and upstream the NOₓ gas compressor 40 (FIGS. 2A and 3A) or b) a pressure higher than P2, for supplying oxygen to the compressed NOₓ gas stream 24 (FIGS. 2B and 3B); a means for controlling the flow of the second oxygen-containing gas 68, 72, 77 such that a tail gas stream 5, 10, 64, 69, 80, 83, 84, 85 contains at least 0.5% by volume oxygen; and a first pressure release means 7 located downstream the heat exchange system 43, for expanding a tail gas stream, to produce a first expanded tail gas 64 at a pressure equal to or higher than P1 and lower than P2, wherein the first pressure release means 7 can at least partly power the NOₓ gas compressor 40.

The production plant is characterized in that the production plant further comprises a first and/or a second means for splitting 55, 82 a gas stream, wherein (i) the first means for splitting 55 is a means for splitting a tail gas stream into a first tail gas stream 10 and a second tail gas stream 80, wherein the first tail gas stream 10 has a pressure equal to or higher than P1 and up to P2 and is in fluid communication with the first oxygen-rich gas 50 and compressed air 34, and wherein the mixing of compressed air 34, the first oxygen-rich gas 50 and the first tail gas stream 10 provides the first oxygen-containing gas 56, and (ii) the second means for splitting 82 is a means for splitting a tail gas stream into a third tail gas stream 83 and a fourth tail gas stream 85, wherein the third tail gas stream 83 has a pressure equal to or higher than P1 and up to P2 and is in fluid communication with compressed air 34 and the first oxygen-rich gas 50, and wherein the mixing of the third tail gas 83, compressed air 34 and the first oxygen-rich gas 50 provides the second oxygen-containing gas 68, 72, 77, and wherein the second oxygen-containing gas 68, 72, 77 is supplied downstream the ammonia converter 37 and upstream the NOₓ gas compressor 40, or the second means for splitting 82 is a means for splitting a tail gas stream into a third tail gas stream 84 and a fourth gas stream 85, and wherein the third tail gas stream 84 is in fluid communication with compressed air 34 and the first oxygen-rich gas 50, and wherein the mixing of the third tail gas 83, compressed air 34 and the first oxygen-rich gas 50 and the pressurization of the mixed third tail gas 83, compressed air 34 and the first oxygen-rich gas 50 in a means for pressurizing 78 provide the second oxygen-containing gas 68, 72, 77 at a pressure higher than P2, and wherein the second oxygen-containing gas 68, 72, 77 is supplied downstream the NOₓ gas compressor 40 and upstream the absorption tower 41.

As defined herein, an oxygen-rich gas is a gas comprising more than 21 vol % of oxygen, more in particular more than 30 vol %, more than 35 vol %, more than 40 vol %, more than 50 vol %, more than 60 vol %, more than 70 vol %, more than 80 vol %, more than 90 vol %, more than 95 vol %, more than 98 vol % and more than 99 vol %, more in particular 100 vol % of oxygen. An oxygen-rich gas can, for example, be provided by an air separation unit or by a water electrolyzer.

As defined herein, an air compressor is capable of providing at least 300000 m³/h of compressed air.

As defined herein, steam is water vapors. As defined herein, the term flow refers to either a volumetric flow or a mass flow.

Typically, the heat exchange system 43 comprises at least two heat exchangers 66, 67. The person skilled in the art will realize that it is possible to split tail gas stream inside the heat exchange system, for example between the heat exchanger 66 and 67. In particular, the production plant comprises further heat exchange systems, such that the gaseous NOₓ stream 22 or the NOₓ compressed gas stream 24 exchange heat with the tail gas 5.

As defined herein, a tail gas stream is any gas stream provided downstream the absorption tower, between the absorption tower 41 and the communication between the first tail gas stream 52 and the first oxygen-rich gas 50.

As defined herein, a means for splitting is any means suitable for splitting a tail gas stream such as to generate e.g. a first tail gas stream 10 and a second sail gas stream 80, or a third tail gas stream 83,84 and a fourth tail gas stream 85. In particular, the means for splitting is a T-connection having one inlet and two outlets, such that a gas flowing through the inlet of the T-connection is split into two gas streams of identical chemical composition.

As defined herein, pressure release means is any suitable means for reducing the pressure of a gas stream. In particular, the pressure release means is a gas expander or a gas ejector. The gas ejector provides the benefits of a simplified equipment, at the same time as the pressure of the tail gas stream being processed through the ejector is reduced. This tail gas stream being processed through the gas ejector is the motive gas and the second gas fed to the ejector can, for example, be ambient air at a pressure lower than the tail gas stream being processed through the gas ejector, for example atmospheric pressure. In particular, the tail gas stream is fed as the motive gas to the ejector and the second gas fed to the ejector is oxygen at a pressure lower than the tail gas stream being processed through the gas ejector. Both the feeding of air or oxygen through the gas ejector contribute to increasing the concentration in the first tail gas stream 10 and/or the third tail gas stream 83, 84 being recycled, thereby reducing the demand on the first oxygen-rich gas 50. In particular, the tail gas stream is fed as the motive gas to the ejector and the second gas fed to the ejector is the NOₓ gas/steam mixture 15 or the gaseous NOₓ stream 22.

The person skilled in the art will realize that the means for splitting can be incorporated inside the pressure release means, provided that the pressure release means includes at least two outlets for the gas stream being depressurized.

As defined herein, a means for regulating the concentration of ammonia and/or of oxygen is any means for suitable for achieving a target concentration of ammonia and/or of oxygen. In particular, such means are gas flow control means, in particular a flow control valve or an orifice or a guide vane, for controlling the flow of the first oxygen-rich gas 50 and/or of the ammonia gas stream 32. In particular, the means is an integrated process control system, in which the concentration of oxygen is measured and the target flow of oxygen is thereby determined and achieved from controlling the flow of the first oxygen-rich gas 50. The oxygen concentration can also be determined from computing, by using the oxygen concentration of the first oxygen-rich gas 50, the flow at which the first oxygen-rich gas 50 and of the ammonia gas stream 32 are introduced in the system, and the relative flow values at which the first oxygen-rich gas 50 and the ammonia gas stream 32 are mixed.

Typically, P1 ranges from 2 to 6 bara and P2 ranges from 9 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

The inventors have found that, instead of supplying primary and secondary air solely as compressed air 34 provided by an air compressor 36, it is possible to recirculate the first tail gas stream 10 and/or the third tail gas stream 83, 84, provided by the first means for splitting 55 and the second means for splitting 82, respectively, particularly when controlling the oxygen content of the recirculated tail gas stream. The first oxygen-rich gas 50 having a pressure P1 and the second oxygen-containing gas 68 respectively provide oxygen to the ammonia converter 37 and to the absorption tower 41, such that, even at reduced amounts of compressed air 34 air provided by the air compressor 36, the concentration of oxygen in the ammonia converter 37 and in the absorption tower 41 is at least equal to that in a state-of-the-art dual pressure nitric acid plant. The separate supply of high pressure oxygen or oxygen-rich gas thus ensures that the oxygen and ammonia concentrations in the ammonia converter allow for the production of nitric acid of a commercial grade. The person skilled in the art will realize that, if the pressure of the first oxygen-rich gas 50 is at a pressure such that the pressure of the first oxygen-containing gas 56 is, the relevant pressure drop being accounted for, lower than the operating pressure of the ammonia converter 37, the first oxygen-rich gas 50 can be compressed through the air compressor 36. The fluid communication between compressed air and the first oxygen-rich gas 50 is then introduced inside the air compressor 36.

Therefore, tail gas can be recirculated both as primary and secondary air. Consequently, less compressed air 34 is to be supplied such that less air has to be compressed and the power demand on the air compressor 34 is reduced. At the same time, the size of the air compressor 36 and that of a conventional second pressure release means 60, in which the tail gas 5 is expanded in a state-of-the-art dual pressure nitric acid plant, are reduced, such that the footprint of the plant is reduced. Furthermore, the NOₓ emissions leaving the production plant are also reduced. Consequently, the size of the treatment unit for treating those NOₓ emissions is reduced with respect to the size in the corresponding state-of-the art dual pressure nitric acid plant.

In one embodiment according to the production plant of the disclosure, the production plant further comprises a means for controlling the flow of the first and/or third tail gas stream 10, 83, 84.

The control of the flow of the first tail gas 10 enables to retain further control on the pressure and temperature inside the ammonia converter 37. Similarly, control of the flow of the third tail gas 83, 84 enables to retain further control on the pressure and temperature inside the absorption tower 41.

In one embodiment according to the production plant of the disclosure, the production plant further comprises one or more of a steam turbine 51, wherein the steam turbine can at least partly power the air compressor and/or NOₓ gas compressor 40; a heat exchanger 79, for exchanging heat between the first expanded tail gas 64 and a tail gas stream 5, particularly a tail gas stream colder than the first expanded tail gas, wherein the first expanded tail gas 64 exits the heat exchanger 79 at a temperature below 300° C., and wherein the first expanded tail gas 64 having exchanged heat with the tail gas 5 is further supplied to the first means for splitting 55, in particular wherein the first expanded tail gas 64 downstream the heat exchanger 79 is in direct fluid communication with the first means for splitting 55, and/or the tail gas 5 at the outlet 6 of the absorption tower 41, in particular the tail gas stream colder than the first expanded tail gas, is split into a third tail gas stream 83, 84 and a fourth tail gas stream 85; a De-NOₓ treatment unit 70; and a second pressure release means 60 for expanding the second tail gas stream 80 to atmospheric pressure, to produce a second expanded tail gas 69.

As defined herein, means for converting steam into power are any means for achieving power from steam. In particular those means are a steam turbine connected to an electric generator.

Advantageously, the first means for splitting 55 and/or the second means for splitting 82 is located downstream the heat exchange system 43. Indeed, both the first tail gas stream 10 and the second tail gas stream 80 are then at an optimal temperature. This means that the first tail gas stream 10 is at a temperature below 300° C., such that the first tail gas stream 10 can be fed to the ammonia converter 37 without the amount of ammonia fed through the stream 32 having to be adjusted, in order to maintain the temperature at which the ammonia converter 37 is operable. Typically, the ammonia converter is operated at a temperature ranging from 800 to 950° C. In addition, the location of the first means for splitting 55 downstream the heat exchange system 43 confers to the second tail gas stream 80 an optimal temperature for being expanded such as to provide an optimum of energy which can be used to power, at least partly, the air compressor 36 or the NOₓ gas compressor 40.

Further, the presence of a steam turbine 51 allows for the recovery of the heat of the steam produced in the ammonia converter 37 and this recovered heat can be used, at least partly, for powering the air compressor 36 or the NOₓ gas compressor 40.

In particular, the tail gas 5 exiting the outlet 6 of the absorption tower 41 is heated in the heat exchanger 73, in particular first in a heat exchanger 67 of the heat exchange system 43 and then in the heat exchanger 73, from an initial temperature ranging from 20 to 250° C., to a temperature ranging from 100 to 450° C. Subsequently, the tail gas exiting the heat exchanger 73 is heated in the heat exchange system 43, particularly in a heat exchanger 66, of the heat exchange system 43, to a temperature ranging from 200 to 550° C. The tail gas exiting the heat exchanger 73 then is at an optimal temperature for being treated in the De-NOₓ treatment unit 70 and, therefore, the De-NOₓ treatment unit 70 is located between the heat exchanger 73 and the tail gas heater 43. The person skilled in the art will, without any difficulty, select the proper location for the De-NOₓ treatment unit 70 such that the operating temperature of the De-NOₓ treatment unit 70 is in agreement with the temperature of the corresponding tail gas stream. In the presence of a De-NOₓ treatment unit 70, the NOₓ emissions leaving the production plant through the second tail gas stream 69,80 are reduced.

In particular, part of the tail gas 5, that is the second tail gas stream 83, 84 provided by the second means for splitting 82, can be recirculated downstream the ammonia converter 37 and upstream the NOₓ gas compressor 40 in the case of the third tail gas stream 83 has a pressure equal to or higher than P1 and lower than P2, or downstream the NOₓ gas compressor 40 and upstream the absorption tower 41 in the case of the third tail gas stream 84 has a pressure higher than P2, which reduces the duty on secondary air to be provided by the air compressor 36.

In one embodiment according to the production plant of the disclosure, the production plant further comprises a bleacher 62 for bleaching the stream of raw nitric acid-containing residual NOₓ gas 27, to provide a stream of bleached nitric acid 75 via outlet 71, the bleacher having a gas inlet 81 in fluid communication with a high-pressure water electrolyzer 63 supplying an oxygen-rich bleaching gas 72, and a gas outlet 73 for off-gases 77 in fluid communication with any gas stream downstream the ammonia converter 37 and upstream the NOₓ gas compressor 40 if the bleacher 62 operates at a pressure equal to or higher than P1 and up to equal to P2 (FIG. 3A), or in fluid communication with any stream downstream the NOₓ gas compressor 40 and upstream the absorption tower 41 if the bleacher 62 operates at a pressure higher than P2 (FIG. 3B), such that the supply for the second oxygen-containing gas 68 comes at least partly from the off-gases 72, 77.

In one embodiment according to the production plant of the disclosure, the oxygen-rich gas 50, the second oxygen-containing gas 68, 72, 77, the oxygen-rich bleaching gas 72 and the oxygen-rich off-gases 77 are provided at least partly by a high-pressure water electrolyzer 63. Stated differently, in particular embodiments, the system of the present disclosure comprises a high-pressure water electrolyzer, wherein the high-pressure water electrolyzer, in particular its anode, is in fluid communication with the compressed air stream, to provide an oxygen-rich gas/compressed air stream mixture.

A water electrolyzer is a device for the electrolysis of water, being the decomposition of water into oxygen and hydrogen gas, due to the passage of an electric current therethrough. This technique can be used to make hydrogen gas, a main component of hydrogen fuel, and oxygen gas. A suitable high-pressure water electrolyzer may comprise an anode producing oxygen gas according to the reaction

2OH-=H₂O+½O₂+2e-;

a cathode, producing hydrogen gas according to the reaction

2H₂O+2e-=H₂+2OH—;

an electrolyte consisting of an alkaline solution such as potassium hydroxide; and a porous diaphragm separating the anode and the cathode, in order to avoid the mixing of hydrogen gas and oxygen gas that together form an explosive mixture. Alternatively, the anode and the cathode may be separated by a solid polymer electrolyte such as the fluoropolymer Nafion, where the electrolyte provides the selective transport of protons from the anode to the cathode, as well as the electrical insulation between the anode and the cathode, and avoids the mixing of hydrogen gas and oxygen gas that together form an explosive mixture.

The anode and cathode can be made of nickel or steel, or mixtures thereof. Alternatively, for the purpose of enhancing the electrode reactions, the anode and cathode may contain catalysts that can be made of Iridium and Platinum, respectively. The diaphragm of an electrically insulating material is based on, for example, zirconia. The diaphragm has a porosity such that it forms a barrier against transport of hydrogen and oxygen gas bubbles, while containing a continuum of penetrated liquid electrolyte. An anode-diaphragm-cathode assembly constitutes an electrolysis cell. Electrolysis cells are piled in series in stacks that compose the core of an electrolyzer. The hydrogen and oxygen production for a given stack volume is proportional to the current density and inversely proportional to the stacking distance. Regardless of stack volume, the hydrogen and oxygen production is proportional to the total current. In addition to the stack, the electrolyzer comprises auxiliaries such as a current rectifier, a water demineralization unit, a water pump and a cooling system, a hydrogen purification unit, and instrumentation.

The electrolyzer is operated by applying a voltage corresponding to the state-of-the-art potential plus the overpotential over each cell. The total voltage depends on the total number of cells of which the electrolyzer is comprised. OH— ions generated at the cathode migrate through the electrolyte in the diaphragm to the anode, where they are consumed by the anode reaction. Electrons travel the opposite direction in an external circuit. A high-pressure water electrolyzer is operated at a pressure higher than P1, or at a pressure higher than P2, in particular higher than 2 bara, in particular as a high pressure water electrolyzer at a high pressure of 9 to 30 bara, more in particular 15 to 30 bara and may be operated at a temperature of 50 to 80° C., or 60 to 80° C.

A high-pressure water electrolyzer hence results in the production of pressurised hydrogen at the cathode and pressurised oxygen at the anode, the produced oxygen and hydrogen gases having a higher pressure than atmospheric pressure. What is required to perform high-pressure electrolysis is to pressurize the water used in the electrolysis process. As pressurizing water requires less power than pressuring a gas, the use of a high-pressure water electrolyzer results in the production of pressurised oxygen-rich gas at minimized power consumption.

When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer. Conveniently, when the stream of raw nitric acid containing residual NOₓ gas 27 is bleached, the supply of the second oxygen-containing gas 68 is achieved through the oxygen-rich bleaching gas 72 and, in turn, through the bleacher 62 and the off-gases 77.

In one embodiment according to the production plant of the disclosure, the production plant further comprises a stream of a second oxygen-rich gas 74 in direct fluid communication with any tail gas stream, particularly a stream of a pressurized oxygen-rich gas in direct fluid communication with any tail gas stream upstream the first pressure release means 7.

The feeding of a stream of a second oxygen-rich gas 74 allows to reduce the amount of the first oxygen-rich gas 50 having to be provided to the mixing unit 35. In particular, the stream of the second oxygen-rich gas 74 can be fed downstream the heat exchange system 43 and upstream the first pressure release means 7, which allows more power to be exported from the first pressure release means 7.

In one embodiment according to the production plant of the disclosure, the production plant further comprises the first oxygen-rich gas 50, the second oxygen-containing gas 68, 72, 77, the stream of the second oxygen-rich gas 74, the oxygen-rich bleaching gas 72 and the off-gases 77 are at least partly provided by a high-pressure water electrolyzer 63.

Conveniently, the high-pressure water electrolyzer 63 provides oxygen to all the various points in the production plant where oxygen needs to be fed. In particular, the supply of oxygen from the electrolyzer 63 is sufficient to provide all of the oxygen of first oxygen-rich gas 50, the second oxygen-rich gas 74, the second oxygen-containing gas 68, the oxygen-rich bleaching gas 72 and the oxygen-rich off-gases 77. In this manner, the system is simplified and can comprise a single source of oxygen from which oxygen-containing gas streams at the desired pressure, following standard pressure adjustment, can be produced. In addition, supplying additional pressurised oxygen-rich gas upstream the absorption tower improves the absorption of NOₓ gases in the absorption tower, which, in its turn, results in additional nitric acid production and reduction of the emissions to the atmosphere. In addition, or alternatively, the size of the absorption tower can be reduced.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

### Method for Producing Nitric Acid

In one aspect of the disclosure, a method for producing nitric acid at reduced power consumption and reduced emissions, in a production plant according to the production plant of the disclosure, is disclosed. The method comprises the steps of a) compressing air in the air compressor 36, thereby providing compressed air 34; b) supplying compressed air 34 obtained in step a) to the mixing apparatus 35; c) supplying the ammonia gas stream 32 to the mixing apparatus 35, thereby producing the ammonia/oxygen-containing gas mixture 14; d) oxidising ammonia in the ammonia/oxygen-containing gas mixture 14 in the ammonia converter 37 at a pressure equal to or higher than P1 and lower than P2, thereby producing the gaseous NOₓ gas/steam mixture 15 comprising water and nitric oxide; e) cooling the NOₓ gas in the gaseous NOₓ gas/steam mixture 15 in the heat exchange system 43 and in the gas/cooler condenser 38, thereby producing an aqueous diluted nitric acid mixture 17 and the gaseous NOₓ stream 22; f) compressing the gaseous NOₓ stream 22 in the NOₓ gas compressor 40, thereby providing the pressurised NOₓ compressed gas stream 24 having a pressure P2; g) absorbing the pressurised gaseous NOₓ stream 24 in the absorption tower 41, thereby providing the stream of raw nitric acid-containing residual NOₓ gas 27 and the tail gas 5 comprising NOₓ gases; h) heating the tail gas 5 in the heat exchange system 43, with the heat from the NOₓ gas/steam mixture 15 coming from the ammonia converter 37, in particular to a temperature ranging from 150 to 650° C.; i) cooling the compressed NOₓ gas stream 24 in the additional gas cooler/condenser 39, in particular thereby providing the compressed NOₓ gas stream 24 having a temperature ranging from 20 to 60° C.; and j) expanding at least part of the tail gas 5 obtained in step h) in the first pressure release means 7, thereby providing the first expanded tail gas 64.

The method is characterized in that it further comprises the steps of k) splitting a stream of tail gas downstream the absorption tower 41 with the first means for splitting 55 into the first tail gas stream 10 and the second tail gas stream 80, and/or with the second means for splitting 82 into the third tail gas stream 83, 84 and the fourth tail gas stream 85; l) mixing the first tail gas stream 10 with the first oxygen-rich gas 50 and compressed air 34, thereby providing the first oxygen-containing gas 56, and/or mixing the third tail gas stream 83, 84 with compressed air 34 and the first oxygen-rich gas 50, thereby providing the second oxygen-containing gas 68, 72, 77; m) adjusting the flow of the first oxygen-rich gas 50 being mixed in step l) or the flow of the ammonia gas stream 32, such as to maintain the oxygen to ammonia molar ratio inside the ammonia converter 37 to a ratio of at least 1.2, in particular between 1.2 and 9; n) supplying the first oxygen-containing gas 56 to the mixing unit 35; o) adjusting the flow of the second oxygen-containing gas 68 such that a tail gas stream 5, 10, 64, 69, 80, 83, 84, 85 (downstream the absorption tower 41) contains at least 0.5% by volume oxygen; and p) supplying the second oxygen-containing gas 68, 72, 77 at a pressure equal to or higher than P1 and up to P2 downstream the ammonia converter 37 and upstream the NOₓ gas compressor 40, or at a pressure higher than P2 downstream the NOₓ gas compressor 40 and upstream the absorption tower 41.

Typically, P1 ranges from 2 to 6 bara and P2 ranges from 9 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

The inventors have found that, instead of supplying primary and secondary air solely as compressed air 34 provided by an air compressor 36, it is possible to recirculate the first tail gas stream 10 and/or the third tail gas stream 83, 84, provided by the first means for splitting 55 and the second means for splitting 82, respectively. The first oxygen-rich gas 50 having a pressure P1 and the second oxygen-containing gas 68 respectively provide oxygen to the ammonia converter 37 and to the absorption tower 41, such that, even at reduced amounts of compressed air 34 air provided by the air compressor 36, the concentration of oxygen in the ammonia converter 37 and in the absorption tower 41 is at least equal to that in a state-of-the-art dual pressure nitric acid plant. The person skilled in the art will realize that, if the pressure of the first oxygen-rich gas 50 is at a pressure such that the pressure of the first oxygen-containing gas 56 is, the relevant pressure drop being accounted for, lower than the operating pressure of the ammonia converter 37, the first oxygen-rich gas 50 can be compressed through the air compressor 36. The fluid communication between compressed air and the first oxygen-rich gas 50 is then introduced inside the air compressor 36.

Therefore, tail gas can be recirculated both as primary and secondary air. Consequently, less compressed air 34 is to be supplied such that less air has to be compressed and the power demand on the air compressor 34 is reduced. At the same time, the size of the air compressor 36 and that of a conventional second pressure release means 60, in which the tail gas 5 is expanded in a state-of-the-art dual pressure nitric acid plant, are reduced, such that the footprint of the plant is reduced. Furthermore, the NOₓ emissions leaving the production plant are also reduced. Consequently, the size of the treatment unit for treating those NOₓ emissions is reduced with respect to the size in the corresponding state-of-the art dual pressure nitric acid plant.

In one embodiment according to the method of the disclosure, the method further comprises the step of q) adjusting the flow of the first and/or the third tail gas stream 10, 83, 84. The control of the flow of the first tail gas 10 enables to retain further control on the pressure and temperature inside the ammonia converter 37. Similarly, control of the flow of the third tail gas 83, 84 enables to retain further control on the pressure and temperature inside the absorption tower 41.

In one embodiment according to the method of the disclosure, the first tail gas stream 10 is mixed in step l), and wherein the expanded tail gas 64 is split in step k), and wherein the method further comprises the steps of r) before step h), heating up, in the heat exchanger 79, the tail gas 5 obtained in step g) with the first expanded tail gas 64 obtained in step j), thereby bringing the tail gas to be mixed in step l) to a temperature below 300° C.; s) treating the tail gas 5 obtained in the De-NOₓ treatment unit 70 before step h) and after step r); t) expanding the second tail gas stream 80 in the second pressure release means 60, thereby providing the second expanded tail gas 69; and u) recovering at least part of the heat energy generated in the ammonia converter 37 in the steam turbine 51. More in particular, the first tail gas stream 10 is mixed in step l), and wherein the expanded tail gas 64 is split in step k), and wherein the method further comprises the steps of r) heating up, in the heat exchanger 79, a tail gas stream which is colder than the first expanded tail gas 64 obtained in step j), thereby bringing the tail gas to be mixed in step l) to a temperature below 300° C.; s) treating the heated tail gas stream from step r) in the De-NOₓ treatment unit 70; t) expanding the second tail gas stream 80 in the second pressure release means 60, thereby providing the second expanded tail gas 69; and u) recovering at least part of the heat energy generated in the ammonia converter 37 in the steam turbine 51.

Advantageously, the first means for splitting 55 is located downstream the heat exchange system 43. Indeed, both the first tail gas stream 10 and the second tail gas stream 80 are then at an optimal temperature. This means that the first tail gas stream 10 is at a temperature below 300° C., such that the first tail gas stream 10 can be fed to the ammonia converter 37 without the amount of ammonia fed through the stream 32 having to be adjusted, in order to maintain the temperature at which the ammonia converter 37 is operable. Typically, the ammonia converter is operated at a temperature ranging from 800 to 950° C. In addition, the location of the first means for splitting 55 downstream the heat exchange system 43 confers to the second tail gas stream 80 an optimal temperature for being expanded such as to provide an optimum of energy which can be used to power, at least partly, the air compressor 36 or the NOₓ gas compressor 40.

Further, the presence of a steam turbine 51 allows for the recovery of the heat of the steam produced in the ammonia converter 37 and this recovered heat can be used, at least partly, for powering the air compressor 36 or the NOₓ gas compressor 40.

In particular, the tail gas 5 exiting the outlet 6 of the absorption tower 41 is heated in the heat exchanger 73, in particular in a heat exchanger 67 of the heat exchange system 43 and then in the heat exchanger 73, from an initial temperature ranging from 20 to 250° C., to a temperature ranging from 100 to 450° C. Subsequently, the tail gas exiting the heat exchanger 79 is heated in the heat exchange system 43, in particular in a heat exchanger 66 of the heat exchange system 43, to a temperature ranging from 200 to 550° C. The tail gas exiting the heat exchanger 79 then is at an optimal temperature for being treated in the De-NOₓ treatment unit 70 and, therefore, the De-NOₓ treatment unit 70 is located between the heat exchanger 73 and the tail gas heater 43. The person skilled in the art will, without any difficulty, select the proper location for the De-NOₓ treatment unit 70 such that the operating temperature of the De-NOₓ treatment unit 70 is in agreement with the temperature of the corresponding tail gas stream. In the presence of a De-NOₓ treatment unit 70, the NOₓ emissions leaving the production plant through the second tail gas stream 69, 80 are reduced.

In particular, part of the tail gas 5, that is the second tail gas stream 83, 84 provided by the second means for splitting 82, can be recirculated downstream the ammonia converter 37 and upstream the NOₓ gas compressor 40 in the case of the third tail gas stream 83 has a pressure equal to or higher than P1 and lower than P2, or downstream the NOₓ gas compressor 40 and upstream the absorption tower 41 in the case of the third tail gas stream 84 has a pressure higher than P2, which reduces the duty on secondary air to be provided by the air compressor 36.

In one embodiment according to the method of the disclosure, the method further comprises the step of v) bleaching the stream of raw nitric acid-containing residual NOₓ gas 27 obtained in step g) in the bleacher 62, thereby producing the stream of bleached nitric acid 75. When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer. In particular, oxygen-rich gas, such as provided by a high-pressure water electrolyzer, may be provided to the bleacher 62 as the bleaching gas 72, thereby generating bleaching off gases 77, which are subsequently mixed with the gaseous NOx stream 22, 24. In this way, an efficient use of an oxygen-rich bleaching gas is made to increase the oxygen content in the absorption tower 41, thereby increasing the absorption of the NOₓ gases in step g) and reducing the corresponding emissions to air. In particular, the oxygen-rich bleaching gas 72 is provided by a high pressure water electrolyzer 63: as less energy is required to pressurize water than to pressurize oxygen gas, pressurized oxygen gas is obtained at minimum power consumption. Conveniently, when the stream of raw nitric acid containing residual NOₓ gas 27 is bleached, the supply of the second oxygen-containing gas 68 is achieved through the oxygen-rich bleaching gas 72 and, in turn, through the bleacher 62 and the off-gases 77.

In one embodiment according to the method of the disclosure, the method further comprises the step of w) supplying the stream of an oxygen-rich gas 74, particularly as a stream of a pressurized oxygen-rich gas, to a tail gas stream, particularly upstream the first pressure release means 7. The feeding of a stream of a second oxygen-rich gas 74 allows to reduce the amount of the first oxygen-rich gas 50 having to be provided to the mixing unit 35. In particular, the stream of the second oxygen-rich gas 74 can be fed downstream the heat exchange system 43 and upstream the first pressure release means 7, which allows more power to be exported from the first pressure release means 7.

In one embodiment according to the method of the disclosure, the method further comprises the step of x) operating the high-pressure water electrolyzer 63, such as at a temperature of 50 to 80° C., or 60 to 80° C., and a gas pressure of 9 to 30 bar, preferably 15 to 30 bar, thereby producing pressurized oxygen-gas; and y) providing, from the oxygen produced by the water electrolyzer 63 in step x), at least part of the first oxygen-rich gas 50, the second oxygen-containing gas 68, 72, 77, the second oxygen-rich gas 74, the oxygen-rich bleaching gas 72 and the off-gases 77. In certain embodiments, the pressurized oxygen or oxygen-rich gas 50 is mixed with the compressed air stream. Conveniently, the high-pressure water electrolyzer 63 provides oxygen to all the various points in the production plant where oxygen needs to be fed. In particular, the supply of oxygen from the electrolyzer 63 is sufficient to provide all of the oxygen of first oxygen-rich gas 50, the second oxygen-rich gas 74, the second oxygen-containing gas 68, the oxygen-rich bleaching gas 72 and the oxygen-rich off-gases 77. In this manner, the system is simplified and can comprise a single source of oxygen from which oxygen-containing gas streams at the desired pressure, following standard pressure adjustment, can be produced.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

### Use of the Production Plant of the Disclosure

In one aspect of the disclosure, the use of the production plant of the disclosure for performing the method of the disclosure, is disclosed.

### Method for Revamping a State-of-the Art Dual Pressure Nitric Acid Production Plant

In one aspect of the disclosure, a method for revamping a production plant for producing nitric acid, comprising an air compressor 36 for providing a compressed air stream 34; a mixing apparatus 35, for mixing compressed air stream 34 with an ammonia gas stream 32, to produce an ammonia/oxygen-containing gas mixture 14; an ammonia converter 37 operable at a pressure equal to or higher than P1 and lower than P2, for oxidising ammonia in the ammonia/oxygen-containing gas mixture 14, to produce a NOₓ gas/steam mixture 15 comprising water and nitric oxide; a first gas cooler/condenser 38, downstream the ammonia converter 37, to produce an aqueous diluted nitric acid mixture 17 and a gaseous NOₓ stream 22; a NOₓ gas compressor 40 for compressing the gaseous NOₓ stream 22, to produce a compressed NOₓ gas stream 24 at a pressure P2; an absorption tower 41 for absorbing the NOₓ gases from the compressed NOₓ gas stream 24 in water, to produce a stream of raw nitric acid-containing residual NOₓ gas 27 and a tail gas 5 comprising NOₓ gases, comprising an absorption tower tail gas outlet 6 for evacuating the tail gas 5; a heat exchange system 43 for heating a tail gas stream with the heat from the NOₓ gas/steam mixture 15 coming from the ammonia converter 37; a second gas cooler/condenser 39 for separating and condensing steam from the compressed NOₓ gas stream 24 before it is absorbed in the absorption tower 41; and first pressure release means 7 for expanding a tail gas stream, to produce a first expanded tail gas 64 at a pressure equal to or higher than P1 and lower than P2, wherein the first pressure release means 7 can at least partly power the NOₓ gas compressor 40 and/or the means for pressurizing 78; into a production plant according to the production plant of the disclosure, is disclosed.

The revamping method comprises the steps of introducing a supply for a first oxygen-rich gas 50 in fluid communication with compressed air 34; introducing a means for regulating (not shown) the concentration of ammonia and/or of oxygen in the ammonia converter 37, particularly a means for controlling the flow of the first oxygen-rich gas 50 in the oxygen-containing gas 56 and/or a means for controlling the flow of the ammonia gas stream 32, for maintaining the oxygen to ammonia molar ratio inside the ammonia converter 37 at a ratio of at least 1.2; introducing a supply for a second oxygen-containing gas 68, 72, 77, having either (a) a pressure equal to or higher than P1 and up to P2, for supplying oxygen upstream the NOₓ gas compressor 40 or (b) a pressure higher than P2, for supplying oxygen to the compressed NOₓ gas stream 24, such that a tail gas stream 5, 10, 64, 69, 80, 83, 84, 85 contains at least 0.5% by volume oxygen; introducing a first means for splitting 55 and/or a second means for splitting 82 a stream of tail gas downstream the absorption tower 41, wherein (i) the first means for splitting 55 is a means for splitting a tail gas stream into a first tail gas stream 10 and a second tail gas stream 80, and wherein the first tail gas stream 10 has a pressure equal to or higher than P1 and up to P2 and is in fluid communication with the first oxygen-rich gas 50 and compressed air 34, and wherein the mixing of compressed air 34, the first oxygen-rich gas 50 and the first tail gas stream 10 provides the first oxygen-containing gas 56, and (ii) the second means for splitting 82 is a means for splitting a tail gas stream into a third tail gas stream 83 and a fourth tail gas stream 85, wherein the third tail gas stream 83 has a pressure equal to or higher than P1 and up to P2 and is in fluid communication with compressed air 34 and the first oxygen-rich gas 50, and wherein the mixing of the third tail gas 83, compressed air 34 and the first oxygen-rich gas 50 provides the second oxygen-containing gas 68, 72, 77, and wherein the second oxygen-containing gas 68, 72, 77 is supplied downstream the ammonia converter 37 and upstream the NOₓ gas compressor 40, or the second means for splitting 82 is a means for splitting a tail gas stream into a third tail gas stream 84 and a fourth gas stream 85, and wherein the third tail gas stream 84 is in fluid communication with compressed air 34 and the first oxygen-rich gas 50, and wherein the mixing of the third tail gas 83, compressed air 34 and the first oxygen-rich gas 50 and the pressurization of the mixed third tail gas 83, compressed air 34 and the first oxygen-rich gas 50 in a means for pressurizing 78 provide the second oxygen-containing gas 68, 72, 77 at a pressure higher than P2, and wherein the second oxygen-containing gas 68, 72, 77 is supplied downstream the NOₓ gas compressor 40 and upstream the absorption tower 41.

As defined herein, an oxygen-rich gas is a gas comprising more than 21 vol % of oxygen, more in particular more than 30 vol %, more than 35 vol %, more than 40 vol %, more than 50 vol %, more than 60 vol %, more than 70 vol %, more than 80 vol %, more than 90 vol %, more than 95 vol %, more than 98 vol % and more than 99 vol %, more in particular 100 vol % of oxygen. An oxygen-rich gas can, for example, be provided by an air separation unit or by a water electrolyzer.

As defined herein, an air compressor is capable of providing at least 300000 m³/h of compressed air.

As defined herein, steam is water vapors. As defined herein, the term flow refers to either a volumetric flow or a mass flow.

Typically, the heat exchange system 43 comprises at least two heat exchangers 66, 67. The person skilled in the art will realize that it is possible to split a tail gas stream inside the heat exchange system, for example between the heat exchanger 66 and 67. In particular, the production plant comprises further heat exchange systems, such that the gaseous NOₓ stream 22 or the NOₓ compressed gas stream 24 exchange heat with the tail gas 5.

As defined herein, a tail gas stream is any gas stream provided downstream the absorption tower, between the absorption tower 41 and the communication between the first tail gas stream 52 and the first oxygen-rich gas 50.

As defined herein, a means for splitting is any means suitable for splitting a tail gas stream such as to generate e.g. a first tail gas stream 10 and a second sail gas stream 80, or a third tail gas stream 83, 84 and a fourth tail gas stream 85. In particular, the means for splitting is a T-connection having one inlet and two outlets, such that a gas flowing through the inlet of the T-connection is split into two gas streams of identical chemical composition.

As defined herein, pressure release means is any suitable means for reducing the pressure of a gas stream. In particular, the pressure release means is a gas expander or a gas ejector. The gas ejector provides the benefits of a simplified equipment, at the same time as the pressure of the tail gas stream being processed through the ejector is reduced. This tail gas stream being processed through the gas ejector is the motive gas and the second gas fed to the ejector can, for example, be ambient air at a pressure lower than the tail gas stream being processed through the gas ejector, for example atmospheric pressure. In particular, the tail gas stream is fed as the motive gas to the ejector and the second gas fed to the ejector is oxygen at a pressure lower than the tail gas stream being processed through the gas ejector. Both the feeding of air or oxygen through the gas ejector contribute to increasing the concentration in the first tail gas stream 10 and/or the third tail gas stream 83, 84 being recycled, thereby reducing the demand on the first oxygen-rich gas 50. In particular, the tail gas stream is fed as the motive gas to the ejector and the second gas fed to the ejector is the NOₓ gas/steam mixture 15 or the gaseous NOₓ stream 22.

The person skilled in the art will realize that the means for splitting can be incorporated inside the pressure release means, provided that the pressure release means includes at least two outlets for the gas stream being depressurized.

As defined herein, a means for regulating the concentration of ammonia and/or of oxygen is any means for suitable for achieving a target concentration of ammonia and/or of oxygen. In particular, such means are gas flow control means, in particular a flow control valve or an orifice or a guide vane, for controlling the flow of the first oxygen-rich gas 50 and/or of the ammonia gas stream 32. In particular, the means is an integrated process control system, in which the concentration of oxygen is measured and the target flow of oxygen is thereby determined and achieved from controlling the flow of the first oxygen-rich gas 50. The oxygen concentration can also be determined from computing, by using the oxygen concentration of the first oxygen-rich gas 50, the flow at which the first oxygen-rich gas 50 and of the ammonia gas stream 32 are introduced in the system, and the relative flow values at which the first oxygen-rich gas 50 and the ammonia gas stream 32 are mixed.

Typically, P1 ranges from 2 to 6 bara and P2 ranges from 9 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

### EXAMPLES

### 1. Recirculation of Tail Gas at 24% and Use of an Additional Tail Gas Expander

Reference is made to FIG. 3A. Ambient air 4 was compressed in an air compressor 36, providing compressed air 34. Ammonia 32 was mixed with compressed air 34 in a mixing apparatus 35. The oxygen to ammonia molar ratio at the inlet of the mixing apparatus was at least 1.2 The resulting ammonia/air mixture 14 was fed to an ammonia converter 37, at a temperature ranging from 800 to 950° C. and operating at a pressure of 5.2 bar. In the ammonia converter 37, ammonia was oxidized over a mixed platinum/rhodium catalyst, thus obtaining a low-pressure NOx gas/steam mixture 15, comprising water and nitric oxide (NO). The heat energy of the mixture coming out of the ammonia converter was recovered using a steam turbine 51 and also by heating the tail gas 5 as is described below. The NOx gas/stream mixture was subsequently cooled down in a water cooler/condenser 38 to a temperature where the water condenses, and an aqueous diluted nitric acid mixture 17 was separated from a gaseous NOx stream 18 and sent to an absorption tower 41. Subsequently, the gaseous NOx stream was further oxidized to further convert the NO to NO₂ and N₂O₄, providing a gaseous NOx stream 22 that was compressed in the NOx gas compressor 40 to a pressure of 12 bar, thereby producing the pressurised NOx gaseous stream 24. The pressurised NOx gaseous stream 24 was cooled down in a cooler/condenser 39 and sent to the absorption tower 41 too. Inside the absorption tower unit 41, the NOx gas reacted with water to produce the tail gas 5 and a stream of raw nitric acid 27 containing residual NOx gas. The heat from the gaseous NOx stream 24 was used for heating the tail gas 5 in the tail gas heater 43 to 575° C., thereby producing a heated tail gas. The heated tail gas was split over a T-tube 55. Following splitting in the T-tube 55, 24% of the heated tail gas was expanded over a tail gas expander 7, thereby providing an expanded tail gas 64 which was then mixed with compressed airstream 34 and an oxygen-rich gas 50 at a pressure of 8 bar, before the resulting compressed air 34/oxygen-rich gas 50/expanded tail gas 64 was mixed with ammonia 32 in the mixing apparatus 35. The steps subsequent to mixing in the mixing apparatus 35 described above were repeated. The oxygen to ammonia molar ratio at the inlet of the mixing apparatus was at least 1.2. The residual 76% of heated tail gas was sent to an additional tail gas expander 60. The residual NOx gas in the raw nitric acid stream 27 was stripped out with a gaseous medium 72 that was oxygen produced by a water electrolyzer 63, inside a bleacher unit 62 operating at about the same pressure as the ammonia converter of 5.2 bar. The water electrolyzer 63 provided the oxygen-rich gas 50 and also oxygen between the ammonia converter 37 and the absorption tower 41, such that the concentration of oxygen in the tail gas 5 was at least 0.5% by volume. The drive power for both the air compressor 36 and the NOx compressor 40 originated from the tail gas expander 7, the additional tail gas expander 60 and the steam turbine 51. The net power associated to the air compressors 36, the NOx gas compressor 40, the tail gas expander 7 and the additional tail gas expander 60 was 37 kW/h/t 100% HNO₃. This power was produced by the steam turbine 51.

### 2. Comparative Example: No Recirculation of Tail Gas

Ambient air 4 was compressed in an air compressor 36, providing compressed air stream 34. Ammonia 32 was mixed with the oxygen-rich gas/compressed air stream mixture 53, in a mixing apparatus 35, and the resulting ammonia/air mixture 14 was fed to an ammonia converter 37, operating at a pressure of 5.2 bar. The oxygen to ammonia molar ratio inside the mixing apparatus 35 was at least 1.2. In the ammonia converter 37, ammonia was oxidized over a mixed platinum/rhodium catalyst, thus obtaining a low-pressure NOx gas/steam mixture 15, comprising water and nitric oxide (NO). The heat energy of the mixture coming out of the ammonia converter was recovered using a steam turbine 51. The NOx gas/stream mixture was subsequently cooled down in a water cooler/condenser 38 to a temperature where the water condenses, and an aqueous diluted nitric acid mixture 17 was separated from a gaseous NOx stream 18 and sent to an absorption tower 41. Subsequently, the gaseous NOx stream was further oxidized to further convert the NO to NO₂ and N₂O₄, providing a gaseous NOx stream 22 that was compressed in the NOx gas compressor 40 to a pressure of 12 bar, thereby producing the pressurised NOx gaseous stream 24. The pressurised NOx gaseous stream 24 was cooled down in a cooler/condenser 39 and sent to the absorption tower 41 too. Inside the absorption tower 41, the high pressure NOx gas reacted with water to produce the tail gas 5 and a stream of raw nitric acid 27 also containing residual NOx gas. The heat from the gaseous NOₓ stream 24 was used for heating the tail gas 5 in the tail gas heater 43 to 450° C. The entire tail gas stream 5 was sent to the tail gas expander 7. The residual NOx gas in the raw nitric acid stream 27 was then stripped out with compressed air 34, inside the bleacher unit 62. The bleacher unit 62 was generally operated at about the same pressure as the ammonia converter, 5.2 bar. The drive power for the air compressor 36 and the NOx compressor 40 originated from the tail gas expander 7 and the steam turbine 51. The net power associated to the air compressor 36, the NOx compressor 40 and the tail gas expander 7 was 75.5 kW/h/t 100% HNO₃. This power was produced by the steam turbine 51.

Therefore, when compared to the example 1, a net power of 39 kWh/t 100% HNO₃ (50%) was saved upon recirculating 24% of the tail gas.

1. A production plant for producing nitric acid at reduced power consumption and reduced emissions, comprising:
an air compressor providing compressed air;
a supply for a first oxygen-rich gas, a mixing of the first oxygen-rich gas and of compressed air providing part of a first oxygen-containing gas;
a mixing apparatus, for mixing the first oxygen-containing gas with an ammonia gas stream, to produce an ammonia/oxygen-containing gas mixture;
an ammonia converter operable at a pressure equal to or higher than P1 and lower than P2, for oxidising ammonia in the ammonia/oxygen-containing gas mixture, to produce a NOx gas/steam mixture comprising water and nitric oxide;
a means for regulating a concentration of ammonia and/or of oxygen in the ammonia converter, including a means for controlling a flow of the first oxygen-rich gas in the oxygen-containing gas and/or a means for controlling a flow of the ammonia gas stream, for maintaining the oxygen to ammonia molar ratio inside the ammonia converter at a ratio of at least 1.2;
a first gas cooler/condenser downstream the ammonia converter, to produce an aqueous diluted nitric acid mixture and a gaseous NOx stream;
a NOx gas compressor for compressing the gaseous NOx stream, to produce a compressed NOₓ gas stream at a pressure P2;
an absorption tower for absorbing NOₓ gases from the compressed NOₓ gas stream in water, to produce a stream of raw nitric acid-containing residual NOₓ gas and a tail gas comprising NOₓ gases, comprising an absorption tower tail gas outlet for evacuating the tail gas;
a heat exchange system located upstream the first gas cooler/condenser for heating a tail gas stream with the heat from the NOₓ gas/steam mixture coming from the ammonia converter;
a second gas cooler/condenser for separating and condensing steam from the compressed NOₓ gas stream before the stream is provided to the absorption tower;
a second oxygen-containing gas, having either:
a) a pressure equal to or higher than P1 and up to P2, for supplying oxygen downstream the ammonia converter and upstream the NOₓ gas compressor; or
b) a pressure higher than P2, for supplying oxygen to the compressed NOₓ gas stream;
a means for controlling the flow of the second oxygen-containing gas such that a tail gas stream contains at least 0.5% by volume oxygen; and
a first pressure release means located downstream the heat exchange system, for expanding a tail gas stream, to produce a first expanded tail gas at a pressure equal to or higher than P1 and lower than P2, wherein the first pressure release means can at least partly power the NOₓ gas compressor and/or the air compressor;
characterized in that the production plant further comprises:
a first and/or a second means for splitting a gas stream, wherein
(i) the first means for splitting is a means for splitting a tail gas stream into a first tail gas stream and a second tail gas stream, wherein the first tail gas stream has a pressure equal to or higher than P1 and up to P2 and is in fluid communication with the first oxygen-rich gas and compressed air, and wherein the mixing of compressed air, the first oxygen-rich gas and the first tail gas stream provides the first oxygen-containing gas, and
(ii) the second means for splitting is a means for splitting a tail gas stream into a third tail gas stream and a fourth tail gas stream, wherein the third tail gas stream has a pressure equal to or higher than P1 and up to P2 and is in fluid communication with compressed air and the first oxygen-rich gas, and wherein the mixing of the third tail gas, compressed air and the first oxygen-rich gas provides the second oxygen-containing gas, and wherein the second oxygen-containing gas is supplied downstream the ammonia converter and upstream the NOₓ gas compressor;
or
the second means for splitting is a means for splitting a tail gas stream into a third tail gas stream and a fourth gas stream, and wherein the third tail gas stream is in fluid communication with compressed air and the first oxygen-rich gas, and wherein the mixing of the third tail gas, compressed air and the first oxygen-rich gas; and the pressurization of the mixed third tail gas, compressed air and the first oxygen-rich gas in a means for pressurizing provide the second oxygen-containing gas at a pressure higher than P2, and wherein the second oxygen-containing gas is supplied downstream the NOₓ gas compressor and upstream the absorption tower.

2. The production plant according to claim 1, wherein the production plant further comprises a means for controlling the flow of the first and/or third tail gas stream.

3. The production plant according to claim 1, wherein the production plant further comprises one or more of:
a steam turbine, wherein the steam turbine can at least partly power the NOₓ gas compressor and/or the air compressor;
a heat exchanger, for exchanging heat between the first expanded tail gas and a tail gas stream colder than the first expanded tail gas wherein the first expanded tail gas exits the heat exchanger at a temperature below 300° C., and wherein:
the first expanded tail gas downstream the heat exchanger is in direct fluid communication with the first means for splitting; and/or
the tail gas stream which is colder than the first expanded tail gas is split into a third tail gas stream and a fourth tail gas stream;
a De-NOₓ treatment unit; and
a second pressure release means for expanding the second tail gas stream to atmospheric pressure, to produce a second expanded tail gas.

4. The production plant according to claim 1, further comprising a bleacher for bleaching the stream of raw nitric acid-containing residual NOₓ gas, to provide a stream of bleached nitric acid, having an inlet in fluid communication with a high-pressure water electrolyzer supplying an oxygen-rich bleaching gas, and an outlet for off-gases in fluid communication with any gas stream downstream the ammonia converter and upstream the NOₓ gas compressor if the bleacher operates at a pressure equal to or higher than P1 and up to equal to P2, or in fluid communication with any stream downstream the NOₓ gas compressor and upstream the absorption tower if the bleacher operates at a pressure higher than P2, such that the supply for the second oxygen-containing gas comes at least partly from the off-gases.

5. The production plant according to claim 1, further comprising a stream of a second oxygen-rich gas in direct fluid communication with any tail gas stream.

6. The production plant according to claim 4, wherein the first oxygen-rich gas, the second oxygen-containing gas, the second oxygen-rich gas, the oxygen-rich bleaching gas and the off-gases are at least partly provided by a high-pressure water electrolyzer.

7. A method for producing nitric acid at reduced power consumption and reduced emissions, in a production plant according to claim 1, comprising steps of:
a) compressing air in the air compressor, thereby providing compressed air;
b) supplying compressed air obtained in step a) to the mixing apparatus;
c) supplying the ammonia gas stream to the mixing apparatus, thereby producing the ammonia/oxygen-containing gas mixture;
d) oxidising ammonia in the ammonia/oxygen-containing gas mixture in the ammonia converter at a pressure equal to or higher than P1 and lower than P2, thereby producing the gaseous NOₓ gas/steam mixture comprising water and nitric oxide;
e) cooling the NOₓ gas in the gaseous NOₓ gas/steam mixture in the heat exchange system and in the first gas cooler/condenser, thereby producing an aqueous diluted nitric acid mixture and the gaseous NOₓ stream;
f) compressing the gaseous NOₓ stream in the NOₓ gas compressor, thereby providing the pressurized NOₓ compressed gas stream having a pressure P2;
g) absorbing the pressurized gaseous NOₓ stream in the absorption tower, thereby providing the stream of raw nitric acid-containing residual NOₓ gas and the tail gas comprising NOₓ gases;
h) heating the tail gas in the heat exchange system, with the heat from the NOₓ gas/steam mixture coming from the ammonia converter;
i) cooling the compressed NOₓ gas stream in the second gas cooler/condenser, thereby providing the compressed NOₓ gas stream having a temperature ranging from 20 to 60° C.; and
j) expanding at least part of the tail gas obtained in step h) in the first pressure release means, thereby providing the first expanded tail gas;
characterized in that the method further comprises the steps of:
k) splitting a tail gas stream with a first means for splitting into a first tail gas stream and a second tail gas stream, and/or with a second means for splitting into a third tail gas stream and a fourth tail gas stream;
l) mixing the first tail gas stream with the first oxygen-rich gas and compressed air, thereby providing the first oxygen-containing gas, and/or mixing the third tail gas stream with compressed air and the first oxygen-rich gas, thereby providing the second oxygen-containing gas;
m) adjusting the flow of the first oxygen-rich gas being mixed in step l) or the flow of the ammonia gas stream to maintain the oxygen to ammonia molar ratio inside the ammonia converter to a ratio of at least 1.2;
n) supplying the first oxygen-containing gas to the mixing apparatus;
o) adjusting the flow of the second oxygen-containing gas such that a tail gas stream contains at least 0.5% by volume oxygen; and
p) supplying the second oxygen-containing gas at a pressure equal to or higher than P1 and up to P2 downstream the ammonia converter and upstream the NOₓ gas compressor, or at a pressure higher than P2 downstream the NOₓ gas compressor and upstream the absorption tower.

8. The method according to claim 7, further comprising the step of:
q) adjusting the flow of the first and/or the third tail gas stream.

9. The method according to claim 7, wherein the first tail gas stream is mixed in step l), and wherein the first expanded tail gas is split in step k), and wherein the method further comprises the steps of:
r) heating up, in the heat exchanger, the tail gas which is colder than the first expanded tail gas with the first expanded tail gas obtained in step j), thereby bringing the tail gas to be mixed in step l) to a temperature below 300° C.;
s) treating the tail gas stream heated in step r) in a De-NOₓ treatment unit;
t) expanding the second tail gas stream in the second pressure release means, thereby providing the second expanded tail gas; and
u) recovering at least part of a heat energy generated in the ammonia converter in a steam turbine.

10. The method according to claim 7, wherein the third tail gas stream is mixed in step l), and wherein the tail gas obtained in step g) is split in step k) into a third tail gas stream and a fourth tail gas stream.

11. The method according to claim 7, further comprising the step of:
v) bleaching the stream of raw nitric acid-containing residual NOₓ gas obtained in step g) in a bleacher, thereby producing a stream of bleached nitric acid.

12. The method according to claim 7, further comprising the step of:
w) supplying the stream of the second oxygen-rich gas to a tail gas stream.

13. The method according to claim 7, further comprising steps of:
x) operating a high-pressure water electrolyzer, thereby producing pressurized oxygen-gas; and
y) providing, from the oxygen produced by the water electrolyzer in step x), at least part of the first oxygen-rich gas, the second oxygen-rich gas, the second oxygen-containing gas, an oxygen-rich bleaching gas and oxygen-rich off-gases.

14. (canceled)

15. A method for revamping an existing production plant for producing nitric acid, wherein the existing production plant comprises:
an air compressor for providing a compressed air stream;
a mixing apparatus, for mixing compressed air stream with an ammonia gas stream, to produce an ammonia/oxygen-containing gas mixture;
an ammonia converter operable at a pressure equal to or higher than P1 and lower than P2, for oxidising ammonia in the ammonia/oxygen-containing gas mixture, to produce a NOₓ gas/steam mixture comprising water and nitric oxide;
a first gas cooler/condenser, downstream the ammonia converter, to produce an aqueous diluted nitric acid mixture and a gaseous NOₓ stream;
a NOx gas compressor for compressing the gaseous NOx stream, to produce a compressed NOx gas stream at a pressure P2;
an absorption tower for absorbing the NOx gases from the compressed NOx gas stream in water, to produce a stream of raw nitric acid-containing residual NOₓ gas and a tail gas comprising NOx gases, comprising an absorption tower tail gas outlet for evacuating the tail gas;
a heat exchange system for heating a tail gas stream with the heat from the NOₓ gas/steam mixture coming from the ammonia converter; a second gas cooler/condenser for separating and condensing steam from the compressed NOₓ gas stream before it is absorbed in the absorption tower; and
first pressure release means for expanding a tail gas stream, to produce a first expanded tail gas at a pressure equal to or higher than P1 and lower than P2, wherein the first pressure release means can at least partly power the NOₓ gas compressor;
into a production plant according to claim 1, wherein the method comprises steps of:
introducing a supply for a first oxygen-rich gas in fluid communication with compressed air;
introducing a means for regulating the concentration of ammonia and/or of oxygen in the ammonia converter, including a means for controlling the flow of the first oxygen-rich gas in the oxygen-containing gas and/or a means for controlling the flow of the ammonia gas stream, for maintaining the oxygen to ammonia molar ratio inside the ammonia converter at a ratio of at least 1.2;
introducing a supply for a second oxygen-containing gas, having either:
(a) a pressure equal to or higher than P1 and up to P2, for supplying oxygen upstream the NOₓ gas compressor; or
(b) a pressure higher than P2, for supplying oxygen to the compressed NOₓ gas stream,
such that a tail gas stream contains at least 0.5% by volume oxygen;
introducing a first means for splitting and/or a second means for splitting a stream of tail gas downstream the absorption tower, wherein
(i) the first means for splitting is a means for splitting a tail gas stream into a first tail gas stream and a second tail gas stream, and wherein the first tail gas stream has a pressure equal to or higher than P1 and up to P2 and is in fluid communication with the first oxygen-rich gas and compressed air, and wherein the mixing of compressed air, the first oxygen-rich gas and the first tail gas stream provides the first oxygen-containing gas, and
(ii) the second means for splitting is a means for splitting a tail gas stream into a third tail gas stream and a fourth tail gas stream, wherein the third tail gas stream has a pressure equal to or higher than P1 and up to P2 and is in fluid communication with compressed air and the first oxygen-rich gas, and wherein the mixing of the third tail gas, compressed air and the first oxygen-rich gas provides the second oxygen-containing gas, and wherein the second oxygen-containing gas is supplied downstream the ammonia converter and upstream the NOₓ gas compressor;
or
the second means for splitting is a means for splitting a tail gas stream into a third tail gas stream and a fourth gas stream, and wherein the third tail gas stream is in fluid communication with compressed air and the first oxygen-rich gas, and wherein the mixing of the third tail gas, compressed air and the first oxygen-rich gas and the pressurization of the mixed third tail gas, compressed air and the first oxygen-rich gas in a means for pressurizing provide the second oxygen-containing gas at a pressure higher than P2, and wherein the second oxygen-containing gas is supplied downstream the NOₓ gas compressor and upstream the absorption tower.

16. The production plant according to claim 5, wherein the stream of a second oxygen-rich gas is a stream of a pressurized oxygen-rich gas and the any tail gas stream is upstream the first pressure release means.

17. The method according to claim 7, wherein tail gas is heated to a temperature ranging from 150 to 650° C.

18. The method according to claim 12, wherein the stream of the second oxygen-rich gas is supplied as a stream of a pressurized oxygen-rich gas to the tail gas stream upstream the first pressure release means.
